(19) United States
(12) Patent Application Publication
(10) Pub. No.: US 2012/0052457 A1
(43) Pub. Date: Mar. 1, 2012

(54) THERMAL PROCESSING APPARATUS

(75) Inventors: Takanori Saito, Oshu-Shi (JP); Makoto Nakajima, Oshu-Shi (JP)

(73) Assignee: Tokyo Electron Limited, Minato-Ku (JP)

(21) Appl. No.: 13/196,330

(22) Filed: Aug. 2, 2011

(30) Foreign Application Priority Data
Aug. 27, 2010 (JP) 2010-191004

(51) Int. Cl. F27B 11/00

(52) U.S. Cl. 432/206

(57) ABSTRACT

There is provided a thermal processing apparatus in which the outer shell of a vacuum insulation layer-forming structure has an increased buckling strength. The thermal processing apparatus 1 includes a cylindrical reaction tube 3, a boat 5 for holding wafers W, a heater 2 provided around the reaction tube 3, and a vacuum insulation layer-forming structure 10 provided around the heater 2. The vacuum insulation layer-forming structure 10 includes an inner shell 11 and an outer shell 12 which forms a vacuum insulation layer 10a between the outer shell 12 and the inner shell 11. The outer shell 12 is comprised of a thin plate having an undulating cross-sectional shape formed by plastic forming.

### CROSS-REFERENCE TO RELATED APPLICATION

This application claims the benefit of Japanese Patent Application No. 2010-191004, filed on Aug. 27, 2010, the disclosure of which is incorporated herein by reference in its entirety.

### TECHNICAL FIELD

The present invention relates to a thermal processing apparatus, and more particularly to a thermal processing apparatus provided with a vacuum insulation layer and adapted to perform thermal processing, such as oxidation, diffusion or CVD (chemical vapor deposition), of a silicon wafer.

### BACKGROUND ART

Conventional thermal processing apparatuses include a vertical thermal processing apparatus as disclosed in Patent document 1. The vertical thermal processing apparatus comprises a vertical cylindrical reaction tube which surrounds a space in which wafers to be processed are housed, and a heater which surrounds the reaction tube and heats the interior of the reaction tube. A vacuum insulation layer-forming structure for forming a vacuum insulation layer is provided around the outer periphery of the heater. The vacuum insulation layer of the vacuum insulation layer-forming structure reduces the power consumption of the heater.

The vacuum insulation layer of the vacuum insulation layer-forming structure is kept vacuum in the conventional thermal processing apparatus. The heat insulation layer exhibits high heat insulting properties when it is kept at a high vacuum level. The high vacuum, however, can cause buckling in the walls, especially in the outer wall, of the vacuum insulation layer-forming structure. It is conceivable to use a thick outer wall in order to prevent buckling of the wall. This, however, increases the production cost of the vacuum insulation layer-forming structure.

Patent document 1: Japanese Patent Laid-Open Publication No. H7-283160

Patent document 2: Japanese Patent Laid-Open Publication No. 2004-214283

### SUMMARY OF THE INVENTION

The present invention has been made in view of the above situation in the background art. It is therefore an object of the present invention to provide a thermal processing apparatus which has a vacuum insulation layer-forming structure for forming a vacuum insulation layer to reduce the power consumption of a heater and which can lower the production cost of the vacuum insulation layer-forming structure.

In order to achieve the object, the present invention provides a thermal processing apparatus comprising: an open-bottom cylindrical reaction tube having an opening and a flange at the lower end; a boat to be loaded with wafers and housed in the reaction tube; a heater which surrounds the reaction tube and heats the interior of the reaction tube; and a vacuum insulation layer-forming structure provided around the outer periphery of the heater and including an inner shell and an outer shell which forms a vacuum insulation layer between the outer shell and the inner shell, wherein the inner shell and the outer shell each include a cylindrical body and a ceiling plate that covers a top opening of the cylindrical body, and the outer shell is comprised of a thin plate having an undulating cross-sectional shape formed by plastic forming.

The present invention also provides a thermal processing apparatus comprising: an open-bottom cylindrical reaction tube having an opening and a flange at the lower end; a boat to be loaded with wafers and housed in the reaction tube; a heater which surrounds the reaction tube and heats the interior of the reaction tube; and a vacuum insulation layer-forming structure provided around the outer periphery of the heater and including an inner shell and an outer shell which forms a vacuum insulation layer between the outer shell and the inner shell, wherein the inner shell and the outer shell each include a cylindrical body and a ceiling plate that covers a top opening of the cylindrical body, and the outer shell is comprised of a thin plate and is provided with circumferentially-extending reinforcing ribs.

In a preferred embodiment of the present invention, the lower end of the inner shell and the lower end of the outer shell are coupled via a bottom plate.

In a preferred embodiment of the present invention, an outer surface of the inner shell and an inner surface of the outer shell are reflecting surfaces made by polishing or coating.

The reinforcing ribs may be provided on the inner surface of the outer shell. Alternatively, the reinforcing ribs may be provided on the outer surface of the outer shell.

In a preferred embodiment of the present invention, a hollow space is formed between the inner shell and the outer shell.

In a preferred embodiment of the present invention, a plurality of reflectors, arranged parallel to each other, are provided between the inner shell and the outer shell.

Preferably, each reflector is comprised of a wrinkled foil.

In a preferred embodiment of the present invention, a reflector and a heat insulating member are provided between the inner shell and the outer shell.

In a preferred embodiment of the present invention, the inner shell and the outer shell are each comprised of a thin plate of Hastelloy, Inconel or SUS 310.

According to the present invention, the outer shell of the vacuum insulation layer-forming structure is comprised of a thin plate having an undulating cross-sectional shape formed by plastic forming, or is provided with reinforcing ribs. This can increase the buckling strength of the outer shell, making it possible to prevent buckling in the outer shell even when the vacuum insulation layer of the vacuum insulation layer-forming structure is kept at a high vacuum level.

### BRIEF DESCRIPTION OF THE DRAWINGS

FIG. 1 is a vertical sectional view of a thermal processing apparatus according to an embodiment of the present invention;

FIG. 2 is an enlarged view of the thermal processing apparatus shown in FIG. 1;

FIG. 3 is a diagram showing a variation of the thermal processing apparatus according to the present invention;

FIG. 4 is a diagram showing a variation of the thermal processing apparatus according to the present invention;

FIG. 5 is a diagram corresponding to FIG. 2 and showing a variation of the thermal processing apparatus according to the present invention; and

FIG. 6 is a diagram corresponding to FIG. 2 and showing a variation of the thermal processing apparatus according to the present invention.

### DESCRIPTION OF THE PREFERRED EMBODIMENTS

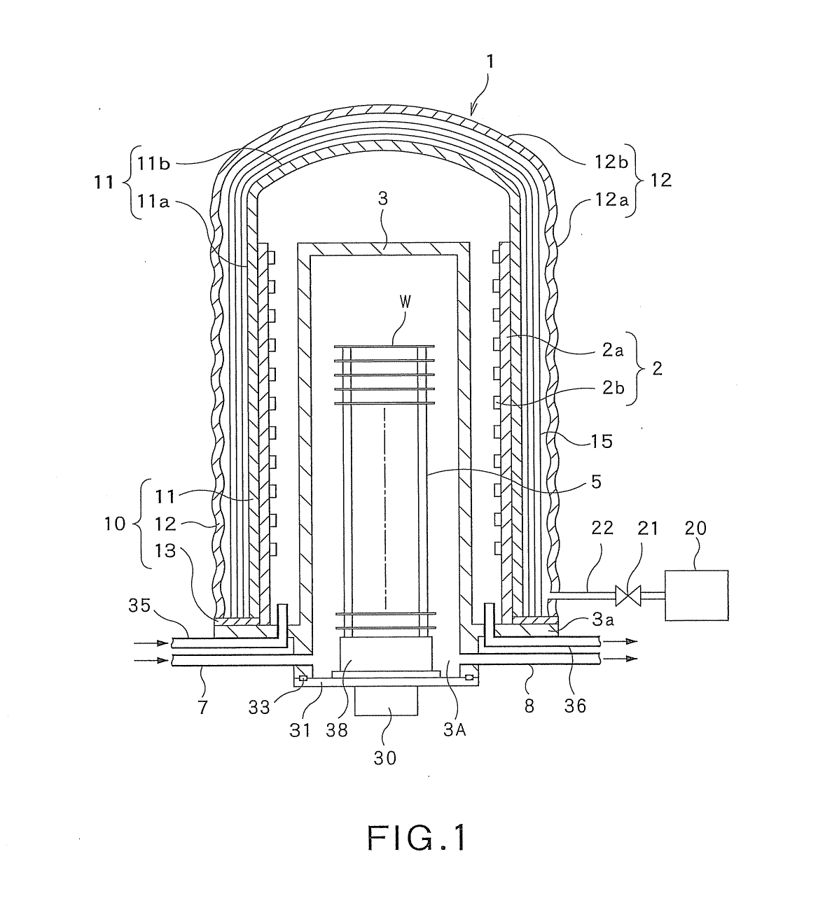

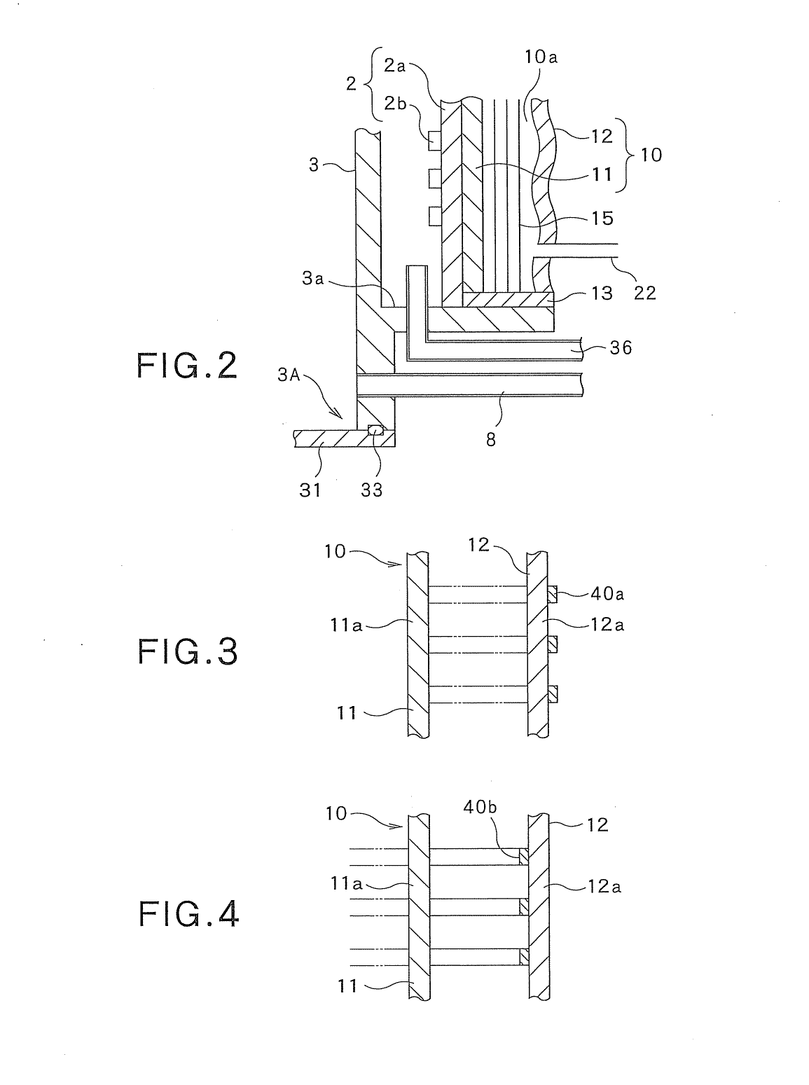

Preferred embodiments of the present invention will now be described with reference to the drawings. FIG. 1 is a schematic cross-sectional view of a thermal processing apparatus according to an embodiment of the present invention, and FIG. 2 is an enlarged view of the thermal processing apparatus.

As shown in FIG. 1, the thermal processing apparatus according to the present invention is a vertical thermal processing apparatus 1 which comprises a cylindrical reaction tube 3 with a closed top and an open bottom with an opening 3A, a boat 5 to be loaded with wafers W and housed in the reaction tube 3, a heater 2 which surrounds the reaction tube 3 and heats the interior of the reaction tube 3, and a vacuum insulation layer-forming structure 10 provided around the outer periphery of the heater 2 such that it covers the top and side surfaces of the reaction tube 3.

The cylindrical reaction tube 3 has a flange 3a at the lower end. The boat 5, loaded with wafers W, is to be housed in the reaction tube 3.

The vacuum insulation layer-forming structure 10 includes an inner shell 11 and an outer shell 12 which forms a vacuum insulation layer 10a between the outer shell 12 and the inner shell 11. The inner shell 11 is comprised of a cylindrical body 11a, constituting the side portion of the inner shell 11, and a ceiling plate 11b which covers a top opening of the cylindrical body 11a. The outer shell 12 is comprised of a cylindrical body 12a, constituting the side portion of the outer shell 12, and a ceiling plate 12b which covers a top opening of the cylindrical body 12a. The inner shell 11 and the outer shell 12 are coupled at their lower ends via a bottom plate 13. The thus-constructed vacuum insulation layer-forming structure 10 is supported on the flange 3a of the reaction tube 3. The vacuum insulation layer-forming structure 10 can be detached from the flange 3a of the reaction tube 3.

The heater 2, which heats the interior of the reaction tube 3, is comprised of a heat insulator 2a composed of ceramic fibers, and a heater element 2b held on the inner surface of the heat insulator 2a.

In cases where low-temperature processing (0-600° C.) is performed, the heater 2 does not necessarily have the heat insulator 2a because of reduced heat capacity.

The vertical thermal processing apparatus 1 can perform thermal processing, such as oxidation, diffusion or CVD (chemical vapor deposition), of a silicon wafer in the manufacturing of a semiconductor device.

As described above, the circumference of the heater 2 is covered with the vacuum insulation layer-forming structure 10. Thus, the heater 2 is located inside the vacuum insulation layer-forming structure 10. The heater element 2b is horizontally divided into a plurality of parts.

To the bottom of the reaction tube 3 are connected a gas introduction pipe (gas introduction passage) 7 and an exhaust pipe (exhaust passage) 8. The gas introduction pipe 7 is connected to a not-shown reactive gas supply source, and the exhaust pipe 8 is connected to a not-shown exhaust apparatus.

The opening 3A is formed in the bottom of the reaction tube 3, so that the boat 5, holding a number of wafers W, can be introduced from the opening 3A into the reaction tube 3. In particular, the boat 5 can be introduced upward into the reaction tube 3 by raising the boat 5 by means of a lifting mechanism (not shown), and can be taken out of the reaction tube 3 by lowing the boat 5.

When the bottom opening 3A of the reaction tube 3 is closed with a furnace lid 31, the connection between the reaction tube 3 and the furnace lid 31 is hermetically sealed by a sealing member 33, such as an O-ring.

As described above, the vacuum insulation layer-forming structure 10 can be detached from the flange 3a of the reaction tube 3. When the vacuum insulation layer-forming structure 10 is on the flange 3a, the connection between the flange 3a and the bottom plate 13 of the vacuum insulation layer-forming structure 10 can be hermetically sealed by a sealing member, such as an O-ring.

The connection between the heat insulator 2a of the heater 2 and the flange 3a can also be hermetically sealed. When the connection between the heat insulator 2a of the heater 2 and the flange 3a is hermetically sealed, the connection between the bottom plate 13 and the flange 3a may not necessarily be hermetically sealed.

When carrying out CVD processing of a wafer W, the wafer W is heated to a predetermined temperature by the heater 2 while a raw material gas is introduced, from the gas introduction pipe 7 into the reaction tube 3. A CVD film is formed on the surface of the wafer W through a reaction of the raw material gas. The gas after reaction is discharged through the exhaust pipe 8.

In order to achieve a uniform in-plane temperature distribution in a wafer W, the boat 5 is mounted via a heat-retaining cylinder 38 on a rotating mechanism 30. The heat-retaining cylinder 38 is provided to prevent non-uniform distribution of temperature among wafers W vertically arranged in the boat 5.

The flange 3a of the reaction tube 3 is provided with an air supply line 35 for cooling the space between the reaction tube 3 and the vacuum insulation layer-forming structure 10. The air in the space between the reaction tube 3 and the vacuum insulation layer-forming structure 10 is discharged through an air exhaust line 36.

The vacuum insulation layer-forming structure 10 will now be described in greater detail. The vacuum insulation layer-forming structure 10 includes the inner shell 11, the outer shell 12 and the bottom plate 13 that couples the lower ends of the inner shell 11 and the outer shell 12. A vacuum insulation layer 10a is formed within the vacuum insulation layer-forming structure 10. The vacuum insulation layer 10a prevents the heat from the heater 2 from escaping to the outside of the vacuum insulation layer-forming structure 10.

A vacuum pump 20 is connected to the vacuum insulation layer-forming structure 10 via a vacuum line 22 having a valve 21. The vacuum insulation layer 10a exerts its vacuum insulating function when the valve 21 is opened and the vacuum pump 20 is actuated.

A plurality of, for example three, reflectors 15 are disposed parallel to each other in the vacuum insulation layer 10a formed in the vacuum insulation layer-forming structure 10.

The reflectors 15 provided within the vacuum insulation layer-forming structure 10, together with the vacuum insulation layer 10a, shut off the heat generated by the heater 2 and conducted outward through the inner shell 11 and, in particular, prevents diffusion of radiant heat form the heater 2.

The reflectors 15 may be formed of a material having a high reflectivity, such as aluminum, silver or gold. The surface of each reflector 15 may be polished to increase the reflectivity.

Alternatively, the reflectors 15 may be composed of a heat-resistant substrate (e.g. Hastelloy, Inconel or SUS 310) for maintaining high-temperature strength, and a vapor-deposited layer of aluminum, silver, gold, or the like, formed on the heat-resistant substrate.

Alternatively, the reflectors 15 may be comprised of thin wrinkled foils of aluminum, silver, gold, or the like, which are in point contact with each other to prevent heat conduction.

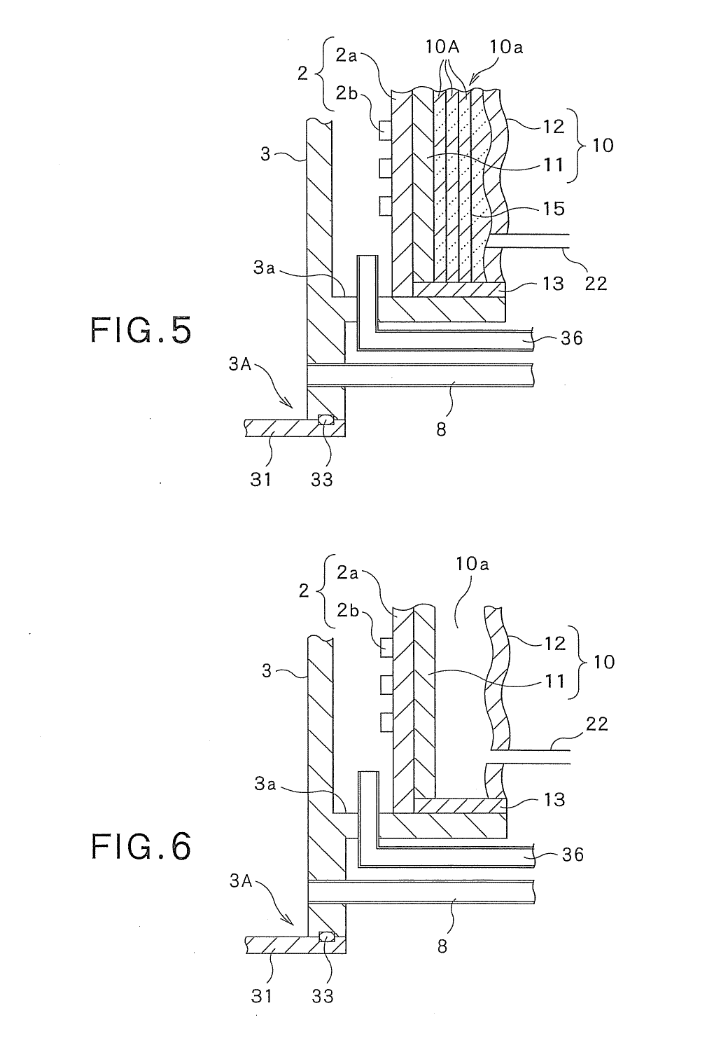

The number of the reflectors 15 provided in the vacuum insulation layer-forming structure 10 is not limited to three. For example, it is possible to provide four or five reflectors 15 arranged parallel to each other. Further, it is possible to provide a heat insulating member(s) 10A of an aluminum-coated silica heat insulating material, which prevents heat conduction, between the inner shell 11 and the reflectors 15, between the outer shell 12 and the reflectors 15, or between two reflectors 15 (see FIG. 5).

It is also possible not to provide the reflectors 15 between the inner shell 11 and the outer shell 12. Thus, a hollow space is formed between the inner shell 11 and the outer shell 12 (see FIG. 6).

The constructions of the inner shell 11, the outer shell 12 and the bottom plate 13, constituting the vacuum insulation layer-forming structure 10, will now be described.

A thin plate of a heat-resistant material, such as stainless steel (e.g. SUS 304 or SUS 310), Hastelloy or Inconel, can be used as a material for forming the inner shell 11, the outer shell 12 and the bottom plate 13.

The outer surface of the inner shell 11 and the inner surface of the outer shell 12, i.e. the inside surfaces of the vacuum insulation layer-forming structure 10, have been polished into reflecting surfaces. This can keep radiant heat in the vacuum insulation layer-forming structure 10 without releasing the heat to the outside. The outer surface of the inner shell 11 and the inner surface of the outer shell 12 may be made reflecting surfaces by means of coating instead of polishing.

The inner surface of the inner shell 11, i.e. the heater 2-side surface of the inner shell 11, may have an SiO₂ coating to prevent oxidation of the inner shell 11.

The inner shell 11, the outer shell 12 and the bottom plate 13 of the vacuum insulation layer-forming structure 10 are each comprised of a heat-resistant thin plate as described above. When the degree of vacuum of the vacuum insulation layer 10a is high, an outward tensile force acts on the inner shell 11, while an inward buckling force acts on the outer shell 12.

The inner shell 11, even though it is comprised of a thin plate, has a tensile strength sufficient to withstand the outward tensile force produced by the high vacuum of the vacuum insulation layer 10a.

On the other hand, in view of the inward buckling force, the cylindrical body 12a of the outer shell 12 has been subjected to plastic forming to form it into an undulating cross-sectional shape (see FIG. 2).

The undulating cross-sectional shape enables the cylindrical body 12a of the outer shell 12 to withstand the inward buckling force produced by the high vacuum of the vacuum insulation layer 10a.

Further, as shown in FIGS. 1 and 2, the ceiling plate 12b of the outer shell 12 has a hemispherical shape in order to increase the buckling strength.

Though in this embodiment only the cylindrical body 12a of the outer shell 12 has an undulating cross-sectional shape, it is also possible to form both the cylindrical body 12a and the ceiling plate 12b in an undulating cross-sectional shape by plastic forming.

FIG. 1 is a schematic cross-sectional view of the thermal processing apparatus 1, and FIG. 2 is an enlarged view of the apparatus.

The operation of the thus-constructed thermal processing apparatus 1 of this embodiment will now be described.

First, the boat 5 loaded with a large number of wafers W is placed on the heat-retaining cylinder 38, and the heat-retaining cylinder 38 and the furnace lid 31 are raised to insert the boat 5 into the reaction tube 3.

Next, the opening 3A of the reaction tube 3 is hermetically closed with the furnace lid 31. The heater 2 is then turned on to heat the wafers W in the reaction tube 3, while a raw material gas is supplied from the gas introduction pipe 7 into the reaction tube 3 to carry out thermal processing of the wafers W.

During the processing, the boat 5 is kept rotating by means of the rotating mechanism 30 so as to uniformly process the wafers W. The gas in the reaction tube 3 is discharged through the exhaust pipe 8.

Because the heater 2 is covered with the vacuum insulation layer-forming structure 10 comprised of the inner shell 11, the outer shell 12 and the bottom plate 13 and in which the vacuum insulation layer 10a is formed, the heat generated by the heater 2 does not diffuse to the outside and the interior of the reaction tube 3 can be efficiently heated by the heat generated by the heater 2.

Upon completion of the thermal processing of the wafers W, the heater 2 is turned off, and the wafers W in the reaction tube 3 are cooled in the following manner.

Cooling air is supplied from the air supply line 35 into the space between the vacuum insulation layer-forming structure 10 and the reaction tube 3 to forcibly cool the wafers W in the reaction tube 3. The air in the pace between the vacuum insulation layer-forming structure 10 and the reaction tube 3 is discharged though the air exhaust line 36.

As described above, the heater 2 is covered with the vacuum insulation layer-forming structure 10. The heat generated by the heater 2 can be prevented from diffusing outward by keeping the vacuum insulation layer 10a in the vacuum insulation layer-forming structure 10 at a high vacuum level.

When the degree of vacuum of the vacuum insulation layer 10a is made high, there is a fear of buckling in the vacuum insulation layer-forming structure 10, especially in the outer shell 12. According to this embodiment, however, the cylindrical body 12a of the outer shell 12 has been formed into an undulating cross-sectional shape by plastic forming. This can increase the buckling strength of the entire outer shell 12. The occurrence of buckling in the outer shell 12 can therefore be prevented even when the degree of vacuum of the vacuum insulation layer 10a is made high.

Further, with the increased buckling strength of the outer shell 12 due to the undulating cross-sectional shape of the cylindrical body 12a, there is no need to thicken the outer shell 12 for the purpose of increasing the buckling strength. Thus, the outer shell 12 can be produced by using a thin plate and subjecting the thin plate to plastic forming. This can lower the production costs of the outer shell 12 and the vacuum insulation layer-forming structure 10 and can reduce the weight of the vacuum insulation layer-forming structure 10.

Variations of the thermal processing apparatus of this embodiment will now be described with reference to FIGS. 3 and 4.

Though in this embodiment the cylindrical body 12a of the outer shell 12 of the vacuum insulation layer-forming structure 10 is made to have an undulating cross-sectional shape to increase the buckling strength of the outer shell 12, it is also possible to increase the buckling strength of the outer shell 12 (cylindrical body 12a) by attaching a plurality of circumferentially-extending reinforcing ribs 40a to the outer surface of the cylindrical body 12a of the outer shell 12 by welding as shown in FIG. 13.

Alternatively, as shown in FIG. 4, the buckling strength of the outer shell 12 (cylindrical body 12a) can be increased by attaching a plurality of circumferentially-extending reinforcing ribs 40b to the inner surface of the cylindrical body 12a of the outer shell 12 by welding.

1. A thermal processing apparatus comprising:
an open-bottom cylindrical reaction tube having an opening and a flange at the lower end;
a boat to be loaded with wafers and housed in the reaction tube;
a heater which surrounds the reaction tube and heats the interior of the reaction tube; and
a vacuum insulation layer-forming structure provided around the outer periphery of the heater and including an inner shell and an outer shell which forms a vacuum insulation layer between the outer shell and the inner shell, wherein the inner shell and the outer shell each include a cylindrical body and a ceiling plate that covers a top opening of the cylindrical body, and the outer shell is comprised of a thin plate having an undulating cross-sectional shape formed by plastic forming.

2. A thermal processing apparatus comprising:
an open-bottom cylindrical reaction tube having an opening and a flange at the lower end;
a boat to be loaded with wafers and housed in the reaction tube;
a heater which surrounds the reaction tube and heats the interior of the reaction tube; and
a vacuum insulation layer-forming structure provided around the outer periphery of the heater and including an inner shell and an outer shell which forms a vacuum insulation layer between the outer shell and the inner shell, wherein the inner shell and the outer shell each include a cylindrical body and a ceiling plate that covers a top opening of the cylindrical body, and the outer shell is comprised of a thin plate and is provided with circumferentially-extending reinforcing ribs.

3. The thermal processing apparatus according to claim 1, wherein the lower end of the inner shell and the lower end of the outer shell are coupled via a bottom plate.

4. The thermal processing apparatus according to claim 1, wherein an outer surface of the inner shell and an inner surface of the outer shell are reflecting surfaces made by polishing or coating.

5. The thermal processing apparatus according to claim 2, wherein the reinforcing ribs are provided on the inner surface of the outer shell.

6. The thermal processing apparatus according to claim 2, wherein the reinforcing ribs are provided on the outer surface of the outer shell.

7. The thermal processing apparatus according to claim 1, wherein a hollow space is formed between the inner shell and the outer shell.

8. The thermal processing apparatus according to claim 1, wherein a plurality of reflectors, arranged parallel to each other, are provided between the inner shell and the outer shell.

9. The thermal processing apparatus according to claim 8, wherein each reflector is comprised of a wrinkled foil.

10. The thermal processing apparatus according to claim 1, wherein a reflector and a heat insulating member are provided between the inner shell and the outer shell.

11. The thermal processing apparatus according to claim 1, wherein the inner shell and the outer shell are each comprised of a thin plate of Hastelloy, Inconel or SUS 310.

12. The thermal processing apparatus according to claim 2, wherein the lower end of the inner shell and the lower end of the outer shell are coupled via a bottom plate.

13. The thermal processing apparatus according to claim 2, wherein an outer surface of the inner shell and an inner surface of the outer shell are reflecting surfaces made by polishing or coating.

14. The thermal processing apparatus according to claim 2, wherein a hollow space is formed between the inner shell and the outer shell.

15. The thermal processing apparatus according to claim 2, wherein a plurality of reflectors, arranged parallel to each other, are provided between the inner shell and the outer shell.

16. The thermal processing apparatus according to claim 2, wherein a reflector and a heat insulating member are provided between the inner shell and the outer shell.

17. The thermal processing apparatus according to claim 2, wherein the inner shell and the outer shell are each comprised of a thin plate of Hastelloy, Inconel or SUS 310.
